(19) United States
(12) Patent Application Publication
(10) Pub. No.: US 2026/0166787 A1
(43) Pub. Date: Jun. 18, 2026

(54) IMPROVED BEND RADIUS AND STORED LENGTH IN POLYETHYLENE CONSTRUCTS

(71) Applicant: W. L. Gore & Associates, Inc., Newark, DE (US)

(72) Inventors: Jeffrey B. Duncan, Flagstaff, AZ (US); Thomas R. McDaniel, Flagstaff, AZ (US)

(21) Appl. No.: 19/139,576

(22) PCT Filed: Dec. 15, 2023
(86) PCT No.: PCT/US2023/084334

§ 371 Date: Jun. 16, 2025

Related U.S. Application Data
(60) Provisional application No. 63/433,093, filed on Dec. 16, 2022.

(51) Int. Cl. B29C 44/56; B29C 59/02; B29L 31/00

(52) U.S. Cl. CPC B29C 44/5645; B29C 59/02; B29K 2023/06; B29L 2031/753

(57) ABSTRACT

An article comprising an expanded polyethylene substrate (12) having a longitudinal length, a first zone (14), and a second zone (16). The first zone having a first density and the second zone having a second density, the second density being greater than the first density, and the second zone is embossed.

### CROSS-REFERENCE TO RELATED APPLICATION

This application is a national phase application of PCT Application No.

PCT/US 2023/084334, internationally filed on Dec. 15, 2023, which claims the benefit of Provisional Application No. 63/433,093, filed Dec. 16, 2022, which are incorporated herein by reference in their entireties for all purposes.

### FIELD

The present disclosure relates generally to apparatuses, systems, and methods for embossing expanded polyethylene. More specifically, the disclosure relates to apparatuses, systems, and methods for embossing expanded polyethylene that may be used in medical devices.

### BACKGROUND

Methods used for processing materials are as important as the method can impart specific qualities onto the processed materials. The specific qualities may be necessary for the processed material to function for its intended purpose or may allow the processed materials to be used in new ways. Selection of processing methods is important in a variety of industries, including, but not limited to the medical device industry, and more specifically for implantable medical devices. However, processed materials may be used across various industries and the same properties that are desirable in one industry may also be important in other industries.

Medical devices often need to be adaptable to fit the needs of a patient. For example, implantable devices made of processed materials may need to fit within or be adaptable to a tortuous geometry. In adapting to tortuous geometries, the implantable devices can be formed or manipulated into different configurations.

However, processed materials may experience stress upon being manipulated and therefore it may be susceptible to failure. What is needed are materials that are useful for providing medical devices that can be manipulated without failure when implanted.

### SUMMARY

The present disclosure relates to methods and articles produced by such methods for densifying expanded polyethylene. For example, methods and articles produced by such methods include selectively densifying portions of an expanded polyethylene substrate to create a stored length. This may lead to desirable features such as increased bend radius, kink resistance, and durability, among others.

According to one example (“Example 1”), an article comprises an expanded polyethylene substrate having a longitudinal length, has a first zone and a second zone, wherein the first zone has a first density and the second zone has a second density, the second density being greater than the first density, and wherein the second zone is embossed.

According to another example (“Example 2”), further to Example 1, the expanded polyethylene substrate is at least one of longitudinally or laterally compressed to define a stored length along at least a portion of the longitudinal length.

According to another example (“Example 3”), further to Example 1, the expanded polyethylene substrate is a tubular member.

According to another example (“Example 4”), further to Example 3, the second zone is a ring extending around a circumference of the tubular member at a longitudinal position defined along the longitudinal length.

According to another example (“Example 5”), further to Example 4, the second zone includes a plurality of rings extending around the circumference of the tubular member at a plurality of longitudinal positions defined along the longitudinal length.

According to another example (“Example 6”), further to Example 1, the expanded polyethylene substrate is free of an adhesive.

According to another example (“Example 7”), further to Example 1, the expanded polyethylene substrate includes a plurality of layers of expanded polyethylene coupled together.

According to one example (“Example 8”), a method of forming an article comprises optionally providing an expanded polyethylene substrate having a first density, selectively densifying a portion of the expanded polyethylene substrate to form one or more densified portions of the expanded polyethylene substrate, wherein the expanded polyethylene substrate has one or more un-densified portions with a first density, and wherein the one or more densified portions have a second density that is greater than the first density, wherein the one or more densified portions are arranged adjacent to the one or more un-densified portions.

According to another example (“Example 9”), further to Example 8, the method further comprises forming the expanded polyethylene substrate into a tubular member.

According to another example (“Example 10”), further to Example 9, selectively densifying a portion of the expanded polyethylene substrate includes applying heat to an outer surface of the expanded polyethylene substrate.

According to another example (“Example 11”), further to Example 9, the method further comprises placing the tubular member on a mandrel.

According to another example (“Example 12”), further to Example 11, selectively densifying a portion of the expanded polyethylene substrate includes applying heat to an inner surface of the expanded polyethylene substrate.

According to another example (“Example 13”), further to Example 12, selectively densifying a portion of the expanded polyethylene substrate includes selectively heating portions of the mandrel.

According to another example (“Example 14”), further to Example 8, selectively densifying a portion of the expanded polyethylene substrate includes applying ultrasonic energy to an outer surface of the expanded polyethylene substrate.

According to another example (“Example 15”), further to Example 8, selectively densifying a portion of the expanded polyethylene substrate includes applying ultrasonic energy to an inner surface of the expanded polyethylene substrate.

According to one example (“Example 16”) a method of forming an article comprises optionally providing an expanded polyethylene substrate having a first density, compressing an expanded polyethylene substrate in a longitudinal and/or lateral direction such that the expanded polyethylene substrate is in a longitudinally and/or laterally compressed state, the expanded polyethylene substrate having a first density, selectively densifying a portion of the expanded polyethylene substrate when in the longitudinally and/or laterally compressed state to form a densified portion of the expanded polyethylene substrate, wherein the densified portion includes a second density that is greater than the first density, and releasing the expanded polyethylene substrate from the longitudinally and/or laterally compressed state.

According to another example (“Example 17”), further to Example 16, the method further comprises forming the expanded polyethylene substrate into a tubular member.

According to another example (“Example 18”), further to Example 17, selectively densifying a portion of the expanded polyethylene substrate includes applying heat to an outer surface of the expanded polyethylene substrate.

According to another example (“Example 19”), further to Example 17, the method further comprises placing the tubular member on a mandrel.

According to another example (“Example 20”), further to Example 19, selectively densifying a portion of the expanded polyethylene substrate includes applying heat to an inner surface of the expanded polyethylene substrate.

According to another example (“Example 21”), further to Example 20, selectively densifying a portion of the expanded polyethylene substrate includes selectively heating portions of the mandrel.

According to another example (“Example 22”), further to Example 16, selectively densifying a portion of the expanded polyethylene substrate includes contacting the portion of the expanded polyethylene substrate with a component that is from about 110 degrees Celsius to about 180 degrees Celsius.

According to another example (“Example 23”), further to Example 16, selectively densifying a portion of the expanded polyethylene substrate includes applying ultrasonic energy to an outer surface of the expanded polyethylene substrate.

According to another example (“Example 24”), further to Example 16, selectively densifying a portion of the expanded polyethylene substrate includes applying ultrasonic energy to an inner surface of the expanded polyethylene substrate.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an embossed article of expanded polyethylene in accordance with some embodiments;

FIG. 2 is an embossed article of expanded polyethylene showing an inner surface and an outer surface, in accordance with some embodiments;

FIG. 3 is an embossed article of expanded polyethylene shown in a bent configuration, in accordance with some embodiments;

FIG. 4 is a method of manufacturing an embossed article of expanded polyethylene, in accordance with some embodiments;

FIG. 5 is an embossed article of expanded polyethylene manufactured by the method of FIG. 4, in accordance with some embodiments;

FIG. 6 is a method of manufacturing an embossed article of expanded polyethylene with a stored length, in accordance with some embodiments; and

FIG. 7 is an embossed article of expanded polyethylene manufactured by the method of FIG. 6, in accordance with some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “laminate” as used herein refers to multiple layers of membrane, composite material, or other materials, such as, but not limited to a polymer, such as, but not limited to an elastomer, elastomeric or non-elastomeric material, and combinations thereof.

The term “film” as used herein generically refers to one or more of the membrane, composite material, or laminate The term “polyethylene” (PE) as used herein is inclusive of all types of polyethylene, including but not limited to, expanded polyethylene (ePE).

The term “selective densification” as used herein generally refers to densification at predetermined positions on a substrate and includes various degrees of densification including a partial densification such that the substrate maintains a porous, open microstructure after densification and a full densification in which the substrate has a closed microstructure. Selective densification may include, but is not limited to, densification through a thickness of the substrate or along a length of the substrate and adjacent areas remain un-densified.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

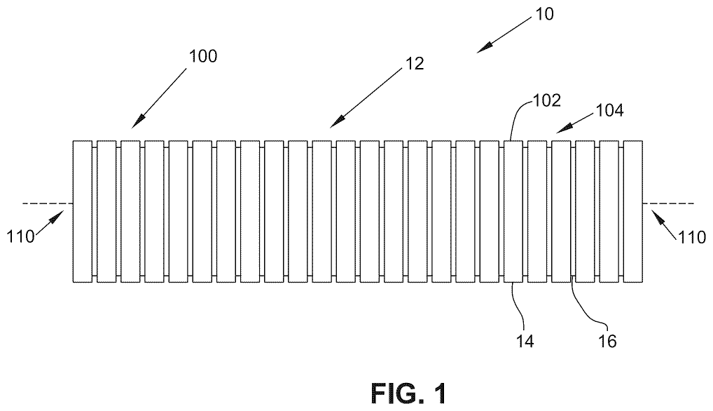

The device shown in FIG. 1 is provided as an example of the various features of the device and, although the combination of those illustrated features is clearly within the scope of invention, that example and its illustration is not meant to suggest the inventive concepts provided herein are limited from fewer features, additional features, or alternative features to one or more of those features shown in FIG. 1.

Various forms of expanded polyethylene may be implemented in the articles and methods, including but not limited to membranes, films, tapes, tubes, and so forth. It is further understood that the expanded polyethylene may be provided with various characteristics including different thicknesses, fibril and node structures, porosity, densities, and so forth. Accordingly, the embodiments discussed herein are not to be limited to specific initial conditions or forms but are understood to broadly incorporate any expanded polyethylene starting material that is suitable for the described methods.

Referring to FIG. 1, an article 10 is illustrated, the article 10 includes an expanded polyethylene substrate 12 having a first zone 14 and a second zone 16. The first zone 14 has a first density and the second zone 16 has a second density. The second density of the second zone 16 is greater than the first density of the first zone 14. Furthermore, the second zone 16 is embossed. The article 10 can be provided in various configurations, including, but not limited to those shown in the figures. The article 10 may be provided in various three-dimensional forms; for example, a tubular member or tubular form as illustrated in FIG. 1. The article 10 may also be formed as a two-dimensional form such as a sheet. A sheet formed of the article 10 may be provided in a variety of configurations, such as a circular form, a rectangular form, or any other geometric form. It is understood that any of the two-dimensional forms may be manipulated to provide a three-dimensional form. For example, the article 10 may be formed by providing a sheet that is coupled (e.g., adhered, bonded, fused and so forth) to itself to form, for example, a tubular member. Providing the article 10 in the various forms may impart specific characteristics to the article 10 that are unique to each form or consistent independent of the form of the article 10.

In one embodiment, such as depicted in FIG. 1, the article 10 is formed as a tubular member 100. The tubular member 100 includes the first and second zones 14, 16 which are operable to impart enhanced durability including resistance to wear when subjected to repetitive bending action, including in implementation where conformability and durability are important factors. Furthermore, the tubular member 100 exhibits kink-resistance, bending radius, conformability, and stored length. Although these features are discussed specifically with regard to the tubular member 100, it is understood that the article 10 provided in other forms may include these and similar features.

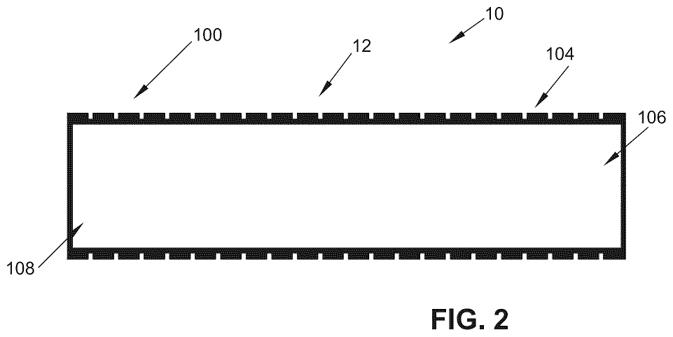

Referring further to FIG. 1, the tubular member 100 is provided with the first and second zones 14, 16, wherein the second zone 16 is a ring 102 that is a densified region positioned (e.g., extending) about a circumference of the tubular member 100. The tubular member 100 may include a plurality of rings 102 that are densified regions of the tubular member 100, where each ring 102 is spaced apart from adjacent rings 102 along a longitudinal length of the tubular member 100. Other geometries of the densified regions outside of circumferential rings are also contemplated. For example, the densified regions can be formed as a helical pattern along the longitudinal length of the tubular member. The longitudinal length may be along a longitudinal axis of the tubular member 110. The rings 102 providing the densified regions act to provide radial support to the tubular member 100 to resist radial forces and collapse, either from exterior forces (e.g., mechanical contact, pressure gradients, etc.) or internal forces (e.g., pressure gradients). The rings 102 may be provided on the tubular member 100 such that an outer surface 104 is recessed and an inner surface 106 is constant (e.g., smooth), for example, as shown in FIG. 2. Having an inner surface 106 that is smooth provides an internal lumen 108 (seen in FIG. 2) through which fluids may flow without disrupting fluid dynamics. Having the outer surface 104 with the recesses may allow for enhanced anchoring of the tubular member 100 within a lumen of a patient. It is understood that the recesses of the ring 102 may alternatively be positioned such that the recesses are formed on the inner surfaces 106 such that the outer surface 104 is smooth. In another alternative embodiment, the recesses formed by the rings 102 may be on both the interior and exterior surfaces 104, 106 (e.g., alternating, zoned, and so forth).

The article 10 may be provided in a variety of structures. In some embodiments, the article 10 includes a plurality of layers of a polymer. For example, the article 10 may be formed as a laminate of layers of expanded polyethylene. The layers may be coupled together via an adhesive, a bonding process, or a mechanical process. In some embodiments, the article 10 is formed into a specific structure, for example, the tubular member 100 previously discussed. The article 10 may be substantially free of an adhesive. In these embodiments, the structure may be formed by bonding a portion of the article 10 to another portion of the article 10, or the article 10 may be provided in the shape of the structure (e.g., extruded, etc.).

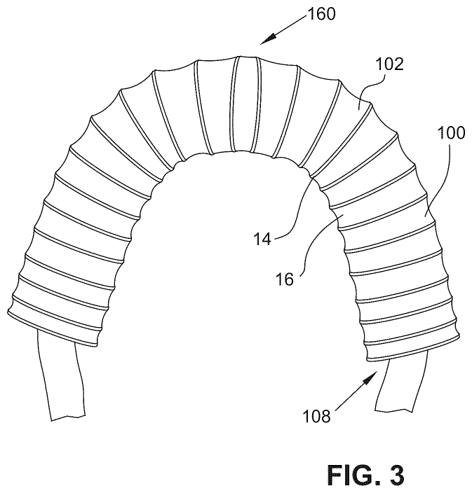

Referring to FIG. 3, an embodiment of the tubular member 100 is illustrated. The tubular member 100 includes a plurality of rings 102 (e.g., the second zone 16 that has been embossed to form a densified portion of the article 10). The tubular member 100 is shown in a bent configuration 160 in which the tubular member 100 is resisting kinking. The rings 102 provided in the tubular member 100 facilitate the tubular member 100 being able to experience a short bend radius without kinking, which allows the internal lumen 108 to stay open and facilitate fluid flow through the interior lumen 108 without occlusion or disruption to fluid dynamics. Because the tubular member 100 is not kinked, the tubular member 100 has greater durability as kinks often define weak spots on an implantable device over time. This is especially true when the implantable device is positioned within a dynamic lumen of a patient that experiences changes is shape, orientation, positions, and so forth.

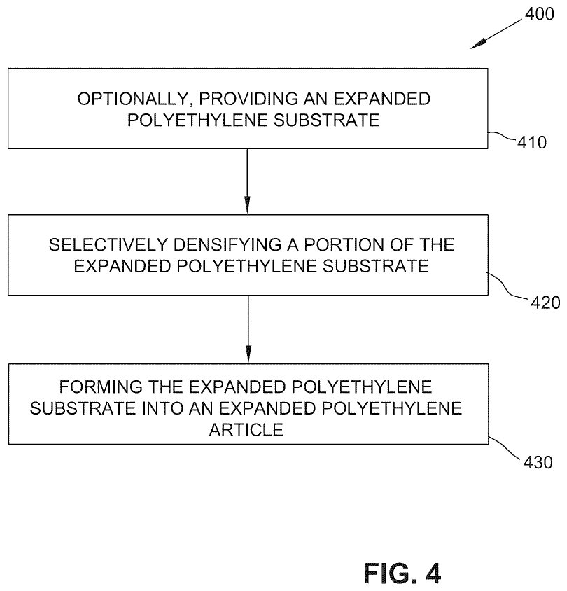

Referring to FIG. 4, a method 400 of forming an article of expanded polyethylene is provided, in accordance with some embodiments. The method of manufacturing may include method steps of providing an expanded polyethylene substrate 410, selectively densifying a portion of the expanded polyethylene substrate 420, and, optionally, forming the expanded polyethylene substrate into an expanded polyethylene article 430.

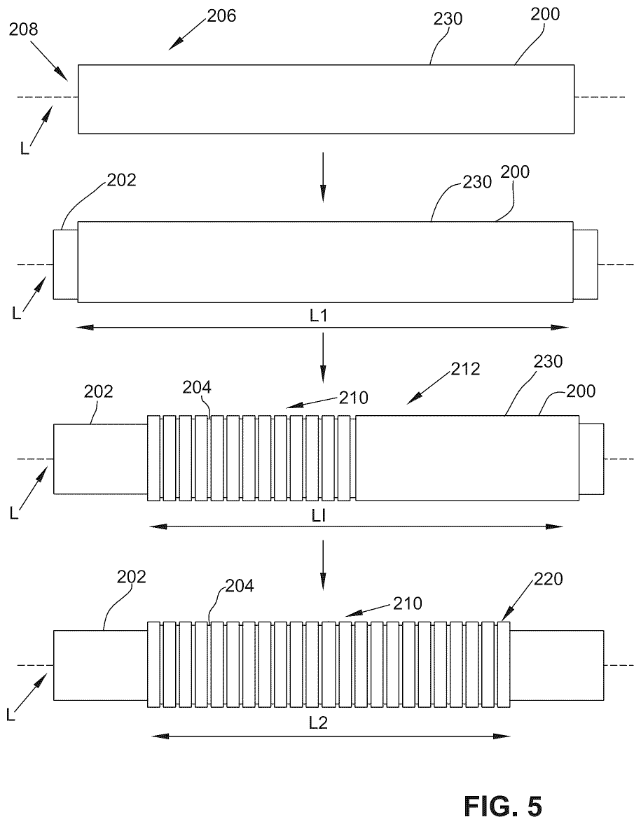

Further referring to FIG. 4, in providing the expanded polyethylene substrate 410, the polyethylene substrate has a first density. The expanded polyethylene substrate may include, but is not limited to, a film, a membrane, a laminate, and so forth. Providing the expanded polyethylene substrate 410 may further include positioning the expanded polyethylene substrate onto a surface (e.g., surface 202 of FIG. 5). The surface may include a mandrel.

Further to FIG. 4, in selectively densifying a portion of the expanded polyethylene substrate 420, a densified portion of the expanded polyethylene substrate is formed (e.g., the second zone 16 of tubular member 100 in FIG. 1). Selective densification refers to densifying the portion the expanded polyethylene substrate 420 such that the density of the portion the expanded polyethylene substrate 420 is increased. In some embodiments, selective densification includes increasing density while also maintaining porosity at the portion of the expanded polyethylene substrate 420 that is selectively densified (e.g., not fully densified such that an open microstructure is retained). In some embodiments, selective densification includes increased density without retaining porosity (e.g., fully densified such that there is not an open microstructure). The portions of the expanded polyethylene substrate 420 that are not selectively densified are porous portions defining un-densified portions. Selective densification may be done through a thickness of the expanded polyethylene substrate 420 or along a length of the expanded polyethylene substrate 420. The densified portion of expanded polyethylene substrate 420 may not be densified through a thickness of the expanded polyethylene substrate 420 such that at least some porosity is retained in the thickness of the expanded polyethylene substrate 420. In some embodiments, the un-densified portions of the expanded polyethylene substrate 420 may be selectively masked such that the un-densified portions remain un-densified and porous. The densified portion of the expanded polyethylene substrate includes a second density, and the second density may be greater than the first density. The densified portion of the expanded polyethylene substrate may be arranged adjacent to the portions of the expanded polyethylene substrate having the first density. Selectively densifying a portion of the expanded polyethylene substrate 420 may be done by embossing. Selectively densifying a portion of the expanded polyethylene substrate 420 may further include applying heat to an outer surface of the expanded polyethylene substrate (e.g., the outer surface 104 of tubular member 100 of FIGS. 1 and 2).

Selectively densifying a portion of the expanded polyethylene substrate 420 may further include applying heat to an inner surface of the expanded polyethylene substrate (e.g., the inner surface 106 of tubular member 100 of FIG. 2). Applying heat to the expanded polyethylene substrate may further include placing the expanded polyethylene substrate onto a mandrel and selectively heating portions of the mandrel (e.g., a surface 202 of FIG. 5).

Further to FIG. 4, the method 400 may optionally further include forming the expanded polyethylene substrate into an expanded polyethylene article 430. The expanded polyethylene article may include a tubular member. Forming the expanded polyethylene into the tubular member may further include placing the tubular member onto the mandrel. In some embodiments, the expanded polyethylene article may be formed by bonding a portion of the article to another portion of the article, or the article may be provided in the shape of the structure (e.g., extruded, etc.).

FIG. 5 illustrates an embossed article of expanded polyethylene 220 manufactured by the method of FIG. 4, in accordance with some embodiments. FIG. 5 includes providing an expanded polyethylene substrate 200 (e.g., a film, membrane, laminate, and so forth). The expanded polyethylene substrate 200 may be a tubular member (e.g., the tubular member 100 of FIG. 1). The expanded polyethylene substrate 200 may have an outer surface 206 and an inner surface 208 (e.g., an inner lumen).

The expanded polyethylene substrate 200 may be positioned on a surface 202 (e.g., a mandrel) in order to further process the expanded polyethylene substrate 200. The expanded polyethylene substrate 200 includes a first density when positioned on the surface 202. The first density may be substantially uniform throughout the expanded polyethylene substrate 200, or there may a portion of the expanded polyethylene substrate 200 having the first density. Once the expanded polyethylene substrate 200 is provided, the expanded polyethylene substrate 200 is positioned with the surface 202, the expanded polyethylene substrate 200 may be selectively densified. The selective densification may include embossing. The embossing may occur via an external device (not shown; e.g., a soldering iron, heated stamp, ultrasonic bonding, etc.), or the embossing may occur via the surface 202 (e.g., the mandrel may be heated, etc.).

Embossing via the external device may selectively densify the outer surface 206 and/or the inner surface 208. Embossing via the surface 202 may selectively densify the inner surface 208.

In some embodiments, the embossing, or selective densification, of the polyethylene substrate 200 may occur via ultrasonic energy. Ultrasonic energy may be applied on the outer surface 206 and/or the inner surface 208 (e.g., using a mandrel) of the polyethylene substrate 200. The ultrasonic energy can be applied using a rotary ultrasonic bonding unit including a horn and anvil assembly. The anvil may include a pattern (e.g., circumferential rings) that can be embossed onto the polyethylene substrate 200. The use of ultrasonic energy may allow the polyethylene substrate 200 to have more discrete differences in density and porosity between the embossed portions and the un-embossed portions of the polyethylene substrate 200. This may be because the un-embossed portions are less affected by the ultrasonic energy than application of heat. This may allow the un-embossed portions to better retain their density and porosity.

As the expanded polyethylene substrate 200 is embossed, the portions that are embossed are densified such that they have a second density that is greater than the first density. The embossing may be done in multiple steps such that the expanded polyethylene substrate 200 has both an embossed portion 210 and an un-embossed portion 212. The embossing may be done along the entire expanded polyethylene substate 200 to create an embossed article 220. It is also understood that as the expanded polyethylene substrate 200 is embossed, the configuration of the embossing (e.g., the pattern) may result in a shortening of the expanded polyethylene substrate 200. For example, FIG. 4, shows the expanded polyethylene substrate 200 provided as a tubular member of expanded polyethylene 230 that is embossed on the outer surface 206 to include circumferential rings 204. When the circumferential rings 204 are embossed into the outer surface 206 of the tubular member of expanded polyethylene 230, a longitudinal length of the tubular member of expanded polyethylene is shortened. The longitudinal length may be defined along a longitudinal axis L of the tubular member of expanded polyethylene. The expanded polyethylene substrate 200 is provided at a first longitudinal length L1. When the embossed portion 210 is formed on a portion of the expanded polyethylene substrate 200, the expanded polyethylene substrate 200 has an intermediate longitudinal length LI. The intermediate longitudinal length LI is shorter than the first longitudinal length L1. When the embossed portion 210 is formed on the whole length of the expanded polyethylene substrate 200 to create the embossed tubular article 220, the embossed tubular article 220 has a second longitudinal length L2. The second length L2 is shorter than the intermediate length LI. In some embodiments, the length change between the first longitudinal length L1 and the second longitudinal length L2 is small.

It is also understood that the densification or embossing process may or may not densify the expanded polyethylene substrate 200 through the entire thickness of the embossed portion 210 of the expanded polyethylene substrate 200. For example, the expanded polyethylene substrate 200 may be densified only through a portion of the thickness of the expanded polyethylene substrate 200 such that there is a portion of the thickness that is not embossed (e.g., the inner surface 208 of the tubular member of expanded polyethylene 230). The portion of the thickness that is not embossed may substantially retain the first density (e.g., on the inner surface 208). Thus, with the densified portion positioned on the outer surface 206, the density at the embossed portion 210 includes a continuum of densities through the thickness of the expanded polyethylene substrate 200 at the embossed portion 210 when observing a cross section of the expanded polyethylene substrate 200. Thus, the inner surface 208 may substantially retain its porosity and fluid dynamics and/or hemodynamics by substantially retaining the first density.

The embossing or selective densification of the expanded polyethylene substrate 200 may be done by heating the expanded polyethylene substrate 200 with a tool at about the melt temperature of the expanded polyethylene substrate 200 or at about 110° C. to about 180° C. For example, the expanded polyethylene substrate 200 may be selectively heated to a temperature of from about 110° C. to about 120° C., from about 120° C. to about 130° C., from about 130° C. to about 140° C., from about 140° C. to about 150° C., from about 150° C. to about 160° C., from about 160° C. to about 170° C., and from about 170° C. to about 180° C.

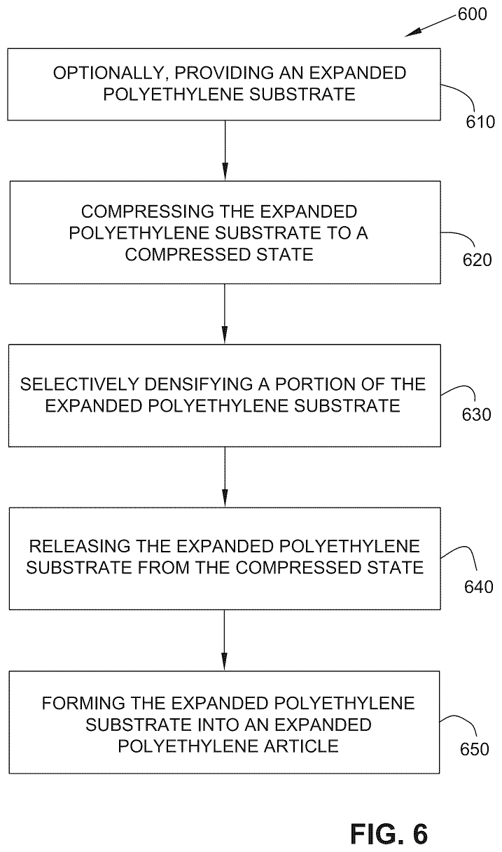

Referring to FIG. 6, a method 600 of forming an article of expanded polyethylene is provided, in accordance with some embodiments. The method of manufacturing may include method steps including providing an expanded polyethylene substrate 610, compressing the expanded polyethylene substrate to a compressed state 620, selectively densifying a portion of the expanded polyethylene substrate 630, releasing the expanded polyethylene substrate from the compressed state 640 and, optionally, forming the expanded polyethylene substrate into an expanded polyethylene article 650.

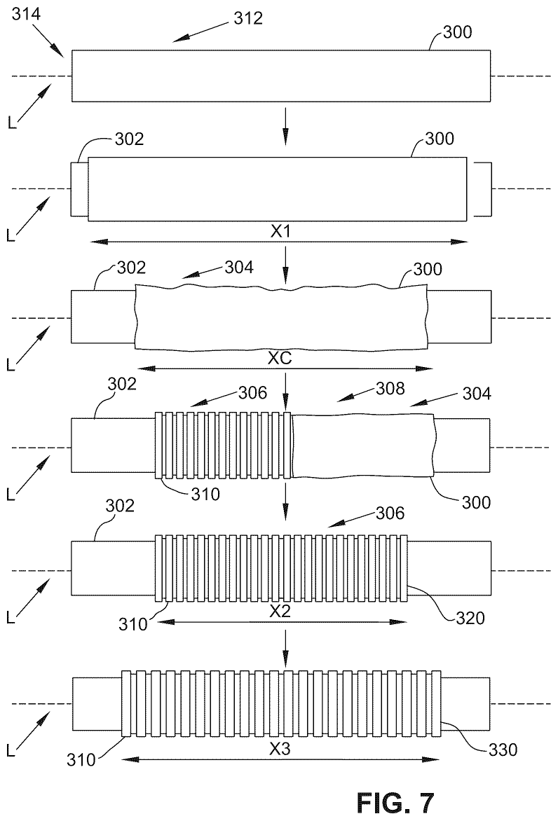

Further referring to FIG. 6, in providing the expanded polyethylene substrate 610, the expanded polyethylene substrate has a first density. The expanded polyethylene substrate may include, but is not limited to, a film, a membrane, a laminate, and so forth. The expanded polyethylene substrate may include a tubular member (e.g., the tubular member of expanded polyethylene 300 of FIG. 7). Providing the expanded polyethylene substrate 610 may further include placing the expanded polyethylene substrate onto a surface. The surface may include a mandrel (e.g., the mandrel 302 of FIG. 7).

Further to FIG. 6, compressing the expanded polyethylene substrate to a compressed state 620 may be done in a longitudinal direction and/or a lateral direction such that the expanded polyethylene substrate is in a longitudinally and/or laterally compressed state.

Further to FIG. 6, selectively densifying a portion of the expanded polyethylene substrate 630 may be done when the expanded polyethylene substrate is in the longitudinally and/or laterally compressed state to form a densified portion of the expanded polyethylene substrate (e.g., the densified portion 306 of FIG. 7). The densified portion includes a second density, and the second density may be greater than the first density. The densified portion of the expanded polyethylene substrate may be arranged adjacent to the un-densified portions (e.g., the un-densified portion 308 of FIG. 7) of the expanded polyethylene substrate having the first density. Selectively densifying a portion of the expanded polyethylene substrate 630 may be done by embossing. Selectively densifying a portion of the expanded polyethylene substrate 630 may further include applying heat to an outer surface (e.g., the outer surface 312 of FIG. 7) of the expanded polyethylene substrate. Selectively densifying a portion of the expanded polyethylene substrate 630 may further include applying heat to an inner surface (e.g., the inner surface 314 of FIG. 7) of the expanded polyethylene substrate 630. Applying heat to the expanded polyethylene substrate 630 may further include placing the expanded polyethylene substrate onto a mandrel and selectively heating portions of the mandrel.

Further to FIG. 6, releasing the expanded polyethylene substrate from the compressed state 640 includes releasing the expanded polyethylene substrate from the longitudinally and/or laterally compressed state. The method 600 may optionally further include forming the expanded polyethylene substrate into an expanded polyethylene article 650. The expanded polyethylene article may include a tubular member. Forming the expanded polyethylene into the tubular member may further include placing the tubular member onto a mandrel.

Further FIG. 7 is an embossed article 10 of expanded polyethylene manufactured by the method of FIG. 6, in accordance with some embodiments. In some embodiments, the embossed article 320 may be provided such that it includes a stored length. This can be accomplished via a method of manufacturing the article 10. The method of manufacturing the article may be substantially similar to the method shown in FIG. 6. For example, the method includes providing an expanded polyethylene substrate, such as a tubular member 300 having a first density, the tubular member 300 being placed on a surface 302 (e.g., a mandrel 302). The expanded polyethylene substate is not limited to the tubular member 300 and may include, but is not limited to, a flat member, or other geometric shape. The expanded polyethylene substrate may be provided at an original length X1. The tubular member 300 includes an outer surface 312 and an inner surface 314 (e.g., an inner lumen). Once the tubular member 300 is positioned, the tubular member 300 is compressed along the longitudinal direction or lateral direction to a compressed state 304 (e.g., not compressed through the thickness of the tubular member 300). In this embodiment, the compressed state 304 is defined in the longitudinal direction, which is defined by a longitudinal axis L of the tubular member 300. The compressed state 304 may have a compressed length XC, which is smaller than the original length X1. While the tubular member 300 is held in the compressed state 304 (e.g., tubular member 300 being held in a longitudinally compressed state 304), the tubular member 300 is selectively densified to form a densified portion 306.

The densified portion 306 may be adjacent to an un-densified portion 308. The densified portion 306 of the tubular member 300 includes a second density that is greater than the first density of the tubular member 300 prior to densification. Selective densification may be done via embossing. Similar to the previous discussion, the embossing process may or may not densify the tubular member 300 through an entire thickness of the tubular member 300 at the densified portion 306. For example, the tubular member 300 may be densified only through a portion of the tubular 300 (e.g., the outer surface 312 of the tubular member 300), such that there is a portion of the thickness of the tubular member 300 that is not densified (e.g., the inner surface 314 of the tubular member 300). The portion of the thickness of the tubular member that is not embossed may substantially retain the first density (e.g., on the inner surface of the tubular member 300). Thus, with the densified portion positioned on the outer surface 312 of the tubular member 300, the density at the densified portion 306 is a continuum of densities through the thickness of the tubular member 300 at the densified portion 306 when observing a cross section of the tubular member 300. Thus, the inner surface of the tubular member may substantially retain its porosity and fluid dynamics and/or hemodynamics. The tubular member 300 may be embossed or densified in various patterns, including but not limited to rings 310. This creates a densified tubular member 320.

After the tubular member 300 is selectively densified, the tubular member 300 is released from the compressed state 304 in which it was held during the densification process. As seen in FIG. 7, when tubular member 300 released from the compressed state 304, the densified tubular member 320 does not rebound to the original length X1 of the tubular member. In some embodiments, a shortened length (or width) X2 of the densified tubular member 320 may be a result of the tubular member 300 being embossed in the compressed state 304. Furthermore, the shortened length (or width) X2 may be a result of the embossing or densification step. Regardless, the tubular member 300 being embossed in the compressed state 304 facilitates a stored length within the expanded polyethylene substrate. By applying a force on either end of the densified tubular member 320, the densified tubular member 320 may be expanded to release the stored length and create an expanded densified tubular member 330. The expanded densified tubular member 330 has an expanded length (or width) X3. The expanded length (or width) X3 may include the full stored length or a portion of the stored length. In the embodiment where the whole stored length is included in the expanded length (or width) X3, the expanded length (or width) X3 may be substantially the same as the original length X1. In other embodiments, the expanded length (or width) X3 may be smaller than the original length X1.

In some embodiments, the expanded polyethylene substrate is not provided as the tubular member 300 and is instead formed into a tubular member. This may occur prior to or after the embossing/densification process described herein. For example, the expanded polyethylene substrate may be formed into a tubular member and then placed on a mandrel for densification, similarly to the densification process shown in FIG. 7. The expanded polyethylene substrate may be formed into a tubular substrate using any appropriate method including extrusion, bonding, adhering, coupling, and so forth. In other embodiments, the expanded polyethylene substrate is embossed/densified prior to forming the tubular member, for example, by bonding, adhering, or otherwise coupling ends of expanded polyethylene substrate that has been embossed to each other.

In some embodiments, embossing/densifying the expanded polyethylene substrate includes selectively applying heat to an outer surface of the expanded polyethylene substrate. In some embodiments, the densification can occur at a temperature above the melt temperature of the expanded polyethylene substrate. In other embodiments, the densification can occur at the melt temperature of an adhesive, if the adhesive is present. In some embodiments, the expanded polyethylene substate is the tubular member 300. The heat can be applied via a heating element such as a soldering iron, a heat press, a heated tooling element, and so forth. The heat is applied to the outer surface (e.g., the outer surface 312 of tubular member 300) so as to maintain the structure character of the interior surface (e.g., the inner surface 314 of the tubular member 300). By maintaining the interior surface of the expanded polyethylene substrate, the characteristics and functionalities may be preserved. For example, the exterior surface may have the densified rings (e.g., rings 310) for structural support (e.g., formed by the densification process) while the interior surface sufficiently retains its structural qualities selected, for example, for hemodynamics, cell adhesion, texture, and so forth. It is understood that the opposite configuration may be implemented in which the interior surfaces may be modified by densification and the exterior surfaces may sufficiently retain structural or other qualities for which the expanded polyethylene substrate was selected. In other embodiments, both the interior surfaces and the exterior surfaces may be modified to facilitate specific features either for the interior surfaces or the exterior surfaces, or for the embossed article 320 defined by the expanded polyethylene substrate (e.g., further resistance to redial collapse, increased stored length, enhanced bending radius, and so forth). The heat may be applied to the expanded polyethylene substrate with a component at about the melt temperature of the expanded polyethylene substrate or at about 110° C. to about 180° C. For example, the expanded polyethylene substrate may be selectively heated to a temperature of from about 110° C. to about 120° C., from about 120° C. to about 130° C., from about 130° C. to about 140° C., from about 140° C. to about 150° C., from about 150° C. to about 160° C., from about 160° C. to about 170° C., and from about 170° C. to about 180° C. In some embodiments in which the expanded polyethylene substrate is formed into a tubular member 300 prior to embossing/densifying, the tubular member is placed onto a mandrel 302. When the tubular member is on the mandrel 302, the mandrel 302 may be selectively heated (e.g., in selected regions including strips, patterns, and so forth). This facilitates embossing/densification of the inner surfaces of the tubular member 300.

Although various materials may be implemented in accordance with the disclosure, in one embodiment shown in FIG. 3, a multilayer expanded polyethylene substrate with an open, airy structure without adhesive was provided. The multilayer expanded polyethylene substrate was cigarette wrapped into a tubular member (e.g., the tubular member 100). The multilayer expanded polyethylene substrate was then selectively densified with localized heat (e.g., via a soldering iron) between about 110° C. and about 180° C. (e.g., at about 175° C.). As shown in FIG. 3, the selectively densified multilayer expanded polyethylene substrate exhibits a high degree of bending without the tubular member 100 kinking.

Referring to FIG. 5, in one non-limiting embodiment, a 6-layer, cigarette wrapped, open, airy expanded polyethylene substrate (e.g., provided as the expanded polyethylene substrate 200) may be provided. The multilayer expanded polyethylene substrate is selectively heated to densify portions of the multilayer expanded polyethylene substrate into densified rings (e.g., circumferential rings 204). The multilayer expanded polyethylene substrate is selectively heated with a soldering iron between about 110° C. and about 180° C. (e.g., at about 150° C.). The densified rings are spaced about 2 mm apart from each other along a longitudinal length of the multilayer expanded polyethylene substrate. The multilayer expanded polyethylene substrate may be provided prior to heating at about 9 cm in length (e.g., as built on a mandrel at the first length L1) and is removed from the mandrel having a length of about 7 cm (e.g., the second length L2) due to compression (i.e., densification) from the selective heating to form the densified rings.

Referring to FIG. 7, in one non-limiting embodiment, a 6-layer, cigarette wrapped, open, airy expanded polyethylene substrate may be provided (e.g., provided as tubular member 300) and placed on a mandrel (e.g., surface 302). The multilayer expanded polyethylene substrate is 9 cm in length (e.g., the original length X1). The multilayer expanded polyethylene substrate is scrunched to a length of 5.5 cm. The multilayer expanded polyethylene substrate is selectively heated to densify portions of the multilayer expanded polyethylene substrate into densified rings (e.g., the compressed length XC). The multilayer expanded polyethylene substrate is selectively heated with a soldering iron between about 110° C. and about 180° C. The multilayer expanded polyethylene substrate is the removed from the mandrel. When the multilayer expanded polyethylene substrate is relaxed, the length of the multilayer expanded polyethylene substrate is about 6 cm (e.g., the shortened length X2). The multilayer expanded polyethylene substrate includes stored length which allows the multilayer expanded polyethylene substrate to be stretched to a length greater than 6 cm (e.g., the expanded length X3). In some embodiments, the expanded polyethylene substrate can rebound to a length greater than 6 cm either prior to stretching or after stretching.

Although specific embodiments are provided herein, it is understood that different arrangements and material properties may be selected and be treated in the spirit of this disclosure. Furthermore, the specific embodiments provide temperatures, steps, and properties that may be modified while still being within the spirit of this disclosure.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. An article comprising:
an expanded polyethylene substrate having a longitudinal length, a first zone and a second zone, wherein the first zone has a first density and the second zone has a second density, the second density being greater than the first density, and
wherein the second zone is embossed.

2. The article of claim 1, wherein the expanded polyethylene substrate is longitudinally and/or laterally compressed to define a stored length along at least a portion of the longitudinal length.

3. The article of claim 1, wherein the expanded polyethylene substrate is a tubular member.

4. The article of claim 3, wherein the second zone is a ring extending around a circumference of the tubular member at a longitudinal position defined along the longitudinal length.

5. The article of claim 4, wherein the second zone includes a plurality of rings extending around the circumference of the tubular member at a plurality of longitudinal positions defined along the longitudinal length.

6. The article of claim 1, wherein the expanded polyethylene substrate is free of an adhesive.

7. The article of claim 1, wherein the expanded polyethylene substrate includes a plurality of layers of expanded polyethylene coupled together.

8. A method of forming an article, comprising:
selectively densifying a portion of an expanded polyethylene substrate to form one or more densified portions of the expanded polyethylene substrate, wherein the expanded polyethylene substrate has one or more un-densified portions with a first density, and wherein the one or more densified portions have a second density that is greater than the first density, wherein the one or more densified portions are arranged adjacent to the one or more un-densified portions.

9. The method of claim 8, further comprising forming the expanded polyethylene substrate into a tubular member.

10. The method of claim 9, wherein selectively densifying a portion of the expanded polyethylene substrate includes applying heat to an outer surface of the expanded polyethylene substrate.

11. The method of claim 9, further comprising placing the tubular member on a mandrel.

12. The method of claim 11, wherein selectively densifying a portion of the expanded polyethylene substrate includes applying heat to an inner surface of the expanded polyethylene substrate.

13. The method of claim 12, wherein selectively densifying a portion of the expanded polyethylene substrate includes selectively heating portions of the mandrel.

14. The method of claim 8, wherein selectively densifying a portion of the expanded polyethylene substrate includes applying ultrasonic energy to an outer surface of the expanded polyethylene substrate.

15. The method of claim 8, wherein selectively densifying a portion of the expanded polyethylene substrate includes applying ultrasonic energy to an inner surface of the expanded polyethylene substrate.

16. A method of forming an article, comprising:
compressing an expanded polyethylene substrate in a longitudinal and/or lateral direction such that the expanded polyethylene substrate is in a longitudinally and/or laterally compressed state, the expanded polyethylene substrate having a first density;
selectively densifying a portion of the expanded polyethylene substrate when in the longitudinally and/or laterally compressed state to form a densified portion of the expanded polyethylene substrate, wherein the densified portion includes a second density that is greater than the first density; and
releasing the expanded polyethylene substrate from the longitudinally and/or laterally compressed state.

17. The method of claim 16, further comprising forming the expanded polyethylene substrate into a tubular member.

18. The method of claim 17, wherein selectively densifying a portion of the expanded polyethylene substrate includes applying heat to an outer surface of the expanded polyethylene substrate.

19. The method of claim 17, further comprising placing the tubular member on a mandrel.

20. The method of claim 19, wherein selectively densifying a portion of the expanded polyethylene substrate includes applying heat to an inner surface of the expanded polyethylene substrate.

21. The method of claim 20, wherein selectively densifying a portion of the expanded polyethylene substrate includes selectively heating portions of the mandrel.

22. The method of claim 16, wherein selectively densifying a portion of the expanded polyethylene substrate includes contacting the portion of the expanded polyethylene substrate with a component that is from about 110 degrees Celsius to about 180 degrees Celsius.

23. The method of claim 16, wherein selectively densifying a portion of the expanded polyethylene substrate includes applying ultrasonic energy to an outer surface of the expanded polyethylene substrate.

24. The method of claim 16, wherein selectively densifying a portion of the expanded polyethylene substrate includes applying ultrasonic energy to an inner surface of the expanded polyethylene substrate.
